(19) United States
(12) Patent Application Publication
(10) Pub. No.: US 2014/0337072 A1
(43) Pub. Date: Nov. 13, 2014

(54) ACTIONABLE WORKFLOW BASED ON INTERACTION ANALYTICS ANALYSIS

(71) Applicant: Genesys Telecommunications Laboratories, Inc., Daly City, CA (US)

(72) Inventors: Eric W. Tamblyn, Murphy, TX (US); Herbert Ristock, Walnut Creek, CA (US); Yochai Konig, San Francisco, CA (US)

(21) Appl. No.: 13/893,036

(22) Filed: May 13, 2013

(51) Int. Cl. G06Q 10/06

(52) U.S. Cl. CPC G06Q 10/06311
USPC 705/7.13

(57) ABSTRACT

A system and method for analyzing interactions between end users and contact center agents, and for generating work items. An interaction analytics server analyzes contact center interactions, continuously or in batches, for characteristics including topics, sentiment, satisfaction, and business outcome, and delivers the results to an intelligent workload distribution server, which generates one or more work items for assignment to suitably skilled agents or stakeholders.

### CROSS-REFERENCE TO RELATED APPLICATION(S)

This application is related to and incorporates by reference in their entirety, as if set forth in full, U.S. Pat. No. 7,487,094 (the “'094 patent”), entitled “SYSTEM AND METHOD OF CALL CLASSIFICATION WITH CONTEXT MODELING BASED ON COMPOSITE WORDS”, U.S. patent application Ser. No. 13/689,750 (the “'750 application”), entitled “WORKLOAD DISTRIBUTION WITH RESOURCE AWARENESS”, filed Nov. 29, 2012, U.S. Provisional Application Ser. No. 61/747,242 (the “'242 application”), entitled “FAST OUT-OF-VOCABULARY SEARCH IN LVCSR AND ASR SYSTEMS”, filed Dec. 29, 2012, U.S. Provisional Application Ser. No. 61/791,581 (the “'581 application”), entitled “FAST OUT-OF-VOCABULARY SEARCH IN AUTOMATIC SPEECH RECOGNITION SYSTEMS”, filed Mar. 15, 2013, U.S. patent application Ser. No. 12/339,988 (the “'988 application”), entitled “METHOD AND SYSTEM FOR INTEGRATING AN INTERACTION MANAGEMENT SYSTEM WITH A BUSINESS RULES MANAGEMENT SYSTEM”, filed: Dec. 19, 2008, and U.S. patent application Ser. No. 12/502,072 (the “'072 application”), entitled “SYSTEM FOR ANALYZING INTERACTIONS AND REPORTING ANALYTIC RESULTS TO HUMAN-OPERATED AND SYSTEM INTERFACES IN REAL TIME”, filed Jul. 13, 2009.

### FIELD

The following description relates to task management, and more particularly to automated assignment of work items based on interaction analytics.

### BACKGROUND

Contact centers may be used by an organization to communicate in an efficient and systematic manner with outside parties. Such centers may for example have large numbers of agents staffing telephones, and interacting with outside parties and with each other. Calls may be placed on hold or into an interactive voice response (IVR) system when first connected to the contact center; subsequently an agent may take a call, place it back on hold, transfer the call, conference in another agent, or take other such actions related to the call. Outside parties may also interact with a contact center by other mechanisms, including initiating contact through on-line chat, video, email, and the like.

Currently, the management of a contact center may in some respects be an ad-hoc, manual process. A contact center manager, may, for example, monitor calls handled by contact center agents, determine whether any agents need training, and schedule training as need. In a process referred to as traditional business intelligence (BI), a manager may conduct off-line reviews of records including recordings of phone calls taken by contact center agents, or reports produced by agents describing the nature of complaints received from customers. The manager may identify a common complaint or trend, and assign a person to remedy the root cause of the customer complaints. These approaches are time consuming for a manager and conducting them off line may result in delay in addressing issues. Thus, an automated approach to generating actions based on analysis of interactions is needed.

### SUMMARY

According to one aspect, a system and method of generating work items for contact center agents and stakeholders, using automated analysis of contact center interactions, is provided. An interaction analytics server analyzes contact center interactions, continuously or in batches, for characteristics including topics, sentiment, satisfaction, and business outcome, and delivers the results to an intelligent workload distribution server, which generates one or more work items. These work items are then assigned, e.g., by another server such as a routing server, to suitably skilled agents or stakeholders.

According to an embodiment of the present invention there is provided a method for assigning a work item to a target, the method including, analyzing, by a computing device, a plurality of interactions between end users and employees, to extract a plurality of characteristics from the plurality of interactions; applying a business rule to the plurality of characteristics; generating a work item in response to the application of the business rule; and assigning the work item to a target.

In one embodiment, one of the plurality of interactions is a telephone call.

In one embodiment, a characteristic of the plurality of characteristics is selected from the group consisting of: interaction topic, end user sentiment, agent sentiment, end user satisfaction, business outcome, and combinations thereof.

In one embodiment, the analyzing is performed by a first server and the generating is performed by a second server, in response to receiving a signal from the first server.

In one embodiment, the signal includes a trigger task.

In one embodiment, the second server generates the work item in response to receiving a plurality of trigger tasks indicating a trend in a characteristic.

In one embodiment, the trend is an increasing value of a characteristic.

In one embodiment, the second server generates the work item in response to receiving a plurality of trigger tasks indicating a rate of interactions with a characteristic.

In one embodiment, the target is a contact center agent.

In one embodiment, the target is a contact center stakeholder.

According to an embodiment of the present invention there is provided a system for assigning a work item to a target, the system including: a processor; and a memory, wherein the memory has stored thereon instructions that, when executed by the processor, cause the processor to: analyze a plurality of interactions between end users and employees, to extract a plurality of characteristics from the plurality of interactions; apply a business rule to the plurality of characteristics; generate a work item in response to the application of the business rule; and assign the work item to a target.

In one embodiment, one of the plurality of interactions is a telephone call.

In one embodiment, a characteristic of the plurality of characteristics is selected from the group consisting of: interaction topic, end user sentiment, agent sentiment, end user satisfaction, business outcome, and combinations thereof.

In one embodiment, the analyzing is performed by a first server and the generating is performed by a second server, in response to receiving a signal from the first server.

In one embodiment, the signal includes a trigger task.

In one embodiment, the second server generates the work item in response to receiving a plurality of trigger tasks indicating a trend in a characteristic.

In one embodiment, the trend is an increasing value of a characteristic.

In one embodiment, the second server generates the work item in response to receiving a plurality of trigger tasks indicating a rate of interactions with a characteristic.

In one embodiment, the target is a contact center agent.

In one embodiment, the target is a contact center stakeholder.

### BRIEF DESCRIPTION OF THE DRAWINGS

These and other features and advantages of the present invention will become appreciated as the same become better understood with reference to the specification, claims and appended drawings wherein:

FIG. 1 is a block diagram of a contact center according to an embodiment of the present invention;

FIG. 2 is a block diagram showing high level architecture of a rules system (referred to as GRS) and client applications of the rules system, according to an embodiment of the present invention;

FIG. 3 is a flow chart of a process of creating a business template and a business rule according to an embodiment of the present invention;

FIG. 4 is a block diagram of a system for analyzing interactions and generating work items according to an embodiment of the present invention;

FIG. 5A is a block diagram of a computing device according to an embodiment of the present invention;

FIG. 5B is a block diagram of a computing device according to an embodiment of the present invention;

FIG. 5C is a block diagram of a computing device according to an embodiment of the present invention;

FIG. 5D is a block diagram of a computing device according to an embodiment of the present invention; and

FIG. 5E is a block diagram of a network environment including several computing devices according to an embodiment of the present invention.

### DETAILED DESCRIPTION

The detailed description set forth below in connection with the appended drawings is intended as a description of exemplary embodiments of an actionable workflow based on interaction analytics analysis provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

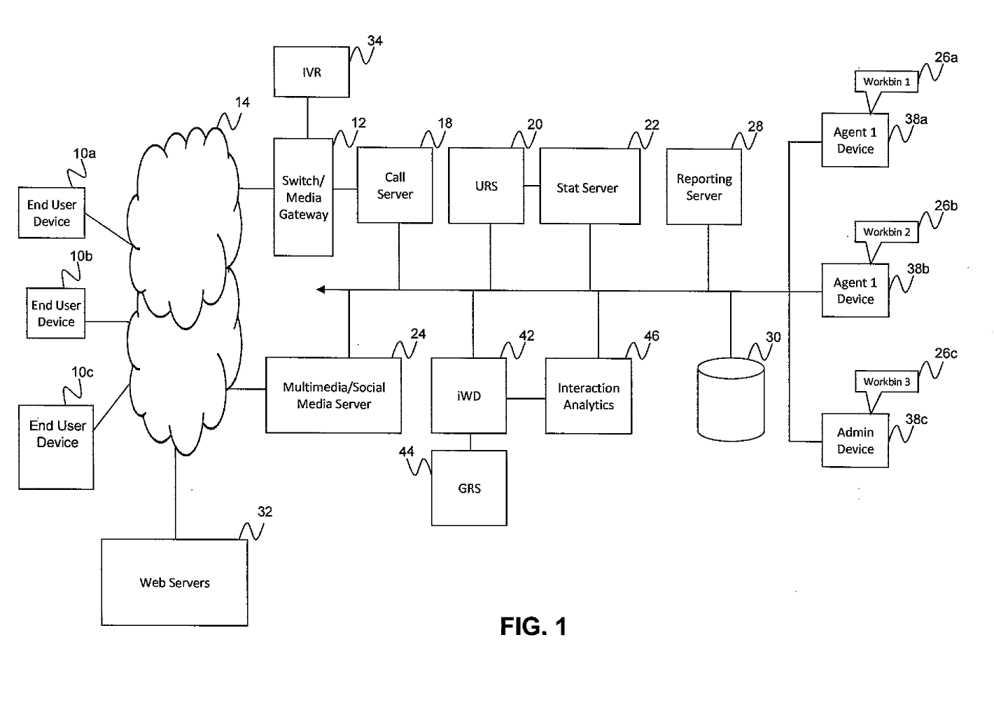

FIG. 1 is a schematic block diagram of a system supporting a contact center according to one exemplary embodiment of the invention. In one embodiment, the system is configured to distribute information and task assignments related to interactions with end users (also referred to as customers), to employees of an enterprise. These task assignments are referred to herein as work items. The contact center may be an in-house facility of the enterprise and may serve the enterprise in performing the functions of sales and service relative to the products and services available through the enterprise. In another exemplary embodiment, the contact center may be a third-party service provider. The contact center may be hosted in equipment dedicated to the enterprise or third-party service provider, and/or hosted in a remote computing environment such as, for example, a private or public cloud environment with infrastructure for supporting multiple contact centers for multiple enterprises.

According to one exemplary embodiment, the contact center includes resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as end users) desiring to receive services from the contact center may initiate inbound calls to the contact center via their end user devices 10a-10c (collectively referenced as 10). Each of the end user devices 10 may be a communication device conventional in the art, such as, for example, a telephone, wireless phone, smart phone, personal computer, electronic tablet, and/or the like. The mechanisms of contact, and the corresponding user devices 10, need not be limited to real-time voice communications as in a traditional telephone call, but may be non-voice communications including text, video, and the like, and may include email or other non-real-time means of communication. This generalized form of a contact between an end user and the contact center, which may include methods of communication other than voice, and an endpoint other than a telephone, is referred to herein as an interaction.

Inbound and outbound interactions from and to the end user devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, and/or any 3G or 4G network conventional in the art.

According to one exemplary embodiment, the contact center includes a switch/media gateway 12 coupled to the communications network 14 for receiving and transmitting interactions and/or data between end users and the contact center. The switch/media gateway 12 may include a telephony switch configured to function as a central switch for agent level routing within the center. In this regard, the switch/media gateway 12 may include an automatic interaction distributor, a private branch exchange (PBX), an IP-based software switch, and/or any other switch configured to receive Internet-sourced interactions and/or telephone network-sourced interactions. According to one exemplary embodiment of the invention, the switch is coupled to a call server 18 which may, for example, serve as an adapter or interface between the switch/media gateway 12 and the remainder of the routing, monitoring, and other interaction-handling systems of the contact center.

The contact center may also include a multimedia/social media server 24, which may also be referred to as an interaction server, for engaging in media interactions other than voice interactions with the end user devices 10 and/or web servers 32. The media interactions may be related, for example, to email, chat, text-messaging, web, social media, and the like. The web servers 32 may include, for example, social interaction site hosts for a variety of known social interaction sites to which an end user may subscribe, such as, for example, FACEBOOK™, TWITTER™, and the like. The web servers may also provide web pages for the enterprise that is being supported by the contact center. End users may browse the web pages and get information about the enterprise's products and services. The web pages may also provide a mechanism for contacting the contact center, via, for example, web chat, voice call, email, web real time communication (WebRTC), or the like.

According to one exemplary embodiment of the invention, the switch is coupled to an interactive voice response (IVR) server 34. The IVR server 34 is configured, for example, with an IVR script for querying customers on their needs. For example, a contact center for a bank may tell callers, via the IVR script, to “press 1” if they wish to get an account balance. If this is the case, through continued interaction with the IVR, customers may complete service without needing to speak with an agent.

If the interaction is to be routed to an agent, the interaction is forwarded to the call server 18 which interacts with a routing server, referred to as a Universal Routing Server (URS) 20, for finding the most appropriate agent for processing the interaction. The call server 18 may be configured to process PSTN calls, VoIP calls, and the like. For example, the call server 18 may include a session initiation protocol (SIP) server for processing SIP calls. In another exemplary embodiment, the call server 18 may include a telephony server (T-server).

In one example, while an agent is being located and until such agent becomes available, the call server may place the interaction in an interaction queue. The interaction queue may be implemented via any data structure conventional in the art, such as, for example, a linked list, array, and/or the like. The data structure may be maintained, for example, in buffer memory provided by the call server 18.

Once an appropriate agent is located and available to handle a call, the call is removed from the call queue and transferred to the corresponding agent device 38a-38b. Collected information about the caller and/or the caller's historical information may also be provided to the agent device for aiding the agent in better servicing the call. The information may also be provided to a stakeholder device 38c for monitoring and training purposes. A stakeholder may be a contact center manager or a supervisor of one or more agents. Stakeholders need not be contact center employees; a product manager employed by the same enterprise, or by another enterprise supported by the contact center, may for example be a stakeholder. Each agent/stakeholder device 38a-c may include a telephone adapted for regular telephone calls, VoIP calls, and the like. The agent and stakeholder devices 38a-c may also include a computer for communicating with one or more servers of the contact center and performing data processing associated with contact center operations.

The selection of an appropriate agent for routing an inbound interaction (e.g. a telephony call or other multimedia interaction) may be based, for example, on a routing strategy employed by the routing server 20, and further based on information about agent availability, skills, agent location, and other routing parameters provided, for example, by a statistics (stat) server 22. For example, the stat server 22 may accumulate data about places, agents, and place/agent groups, convert the data into statistically useful information, and pass the calculations to other software applications. According to one embodiment, the stat server 22 may provide information to the routing server about agents' capabilities in terms of interactions they are handling, the media type of an interaction, and so on.

An exemplary routing strategy employed by the routing server 20 may be that if a particular agent, agent group, or department is requested, the interaction is routed to the requested agent, agent group, or department as soon the requested entity becomes available. If a particular agent has not been requested, the interaction may be routed to agents with the requested skill as soon as those agents become available. If a particular agent group or department has not been requested, the interaction is removed from the routing server queue and routed to an agent group or department handling back-office work. The interaction may be placed into a queue, or for deferred media, the interaction may be placed in a workbin associated with a back-office agent group or department. In some embodiments, the interaction may be routed directly to agents for immediate processing. In this regard, the routing server 20 may be enhanced with functionality for managing back-office/offline activities that are assigned to enterprise employees. Such activities may include, for example, responding to emails and letters, attending training seminars, or performing any other activity (whether related to the contact center or not) that does not entail synchronous, real-time communication with end users. For example, a non-contact center activity that may be routed to a knowledge worker may be to fill out forms for the enterprise, process claims, and the like. Once a work item is assigned to an agent, the work item may appear in the agent's workbin 26a-26b (collectively referenced as 26) as a work item to be completed by the agent. The agent's workbin may be implemented via any data structure conventional in the art, such as, for example, a linked list, array, and/or the like. The workbin may be maintained, for example, in buffer memory of each agent's computer device. A stakeholder device 38c may also have an associated workbin 26c storing work items for which the stakeholder is responsible. Work items may be assigned to various targets, including, as described above, agents and stakeholders, including other persons associated with an enterprise, and including non-human targets such as a servers or computing devices. For example, the assignment of a work item to a target may have the effect of activating a particular email, or a voice response announcing, “You are complaining about a slow internet connection. We are experiencing a problem in your area and are working to resolve it.”

The multimedia/social media server 24 may also be configured to provide, to an end user, a mobile application for downloading onto the end user device 10. The mobile application may provide user configurable settings that indicate, for example, whether the user is available, not available, or availability is unknown, for purposes of being contacted by a contact center agent. The multimedia/social media server 24 may also monitor the status settings.

The contact center may also include a reporting server 28 configured to generate reports from data aggregated by the stat server 22. Such reports may include near real-time reports or historical reports concerning the state of resources, such as, for example, average waiting time, abandonment rate, agent occupancy, and the like. The reports may be generated automatically or in response to specific requests from a requestor (e.g. agent/stakeholder, contact center application, and/or the like).

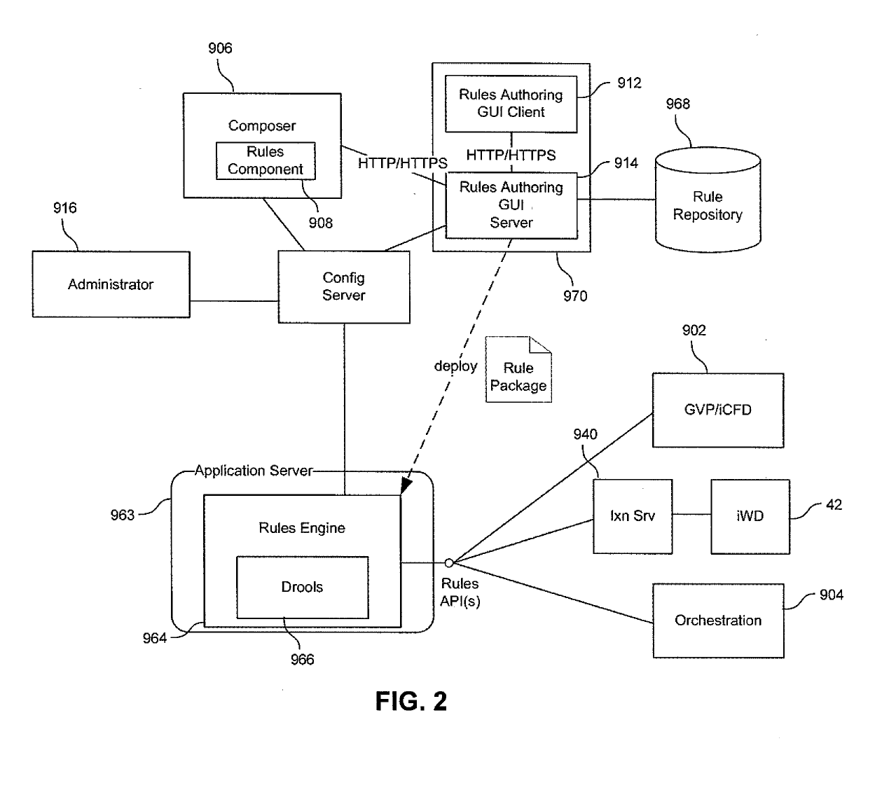

An interaction analytics server 46 may be used to monitor the interactions in the contact center and analyze all or some of them to identify or quantify certain characteristics of the interaction. These characteristics may include topics, sentiment, satisfaction, or business outcome. An intelligent workload distribution server (iWD server) may be used to create work items; the iWD server may employ a rules system (GRS), which may be a separate entity, or which may be an element of the iWD server. A work item may be more effective than, e.g., an email request, in that the system may assign a due date, monitor progress, and escalate the work item to a supervisor if it is not completed. The iWD server may prioritize a work item and specify characteristics, such as particular skills, needed to handle the work item. The work item may then be sent to another server, such as a routing server 20, which, using information provided by a stat server 22, may identify a particular agent with the specified characteristics, e.g., qualified to handle the work item, and assign the work item to that agent. Other components of the system, such as an orchestration/routing server 904 (FIG. 2) may also employ the GRS 44.

According to one exemplary embodiment of the invention, the contact center also includes a mass storage device 30 for storing data related to contact center operations such as, for, example, information related to agents, customers, customer interactions, and the like. The mass storage device may take the form of a hard disk or disk array as is conventional in the art.

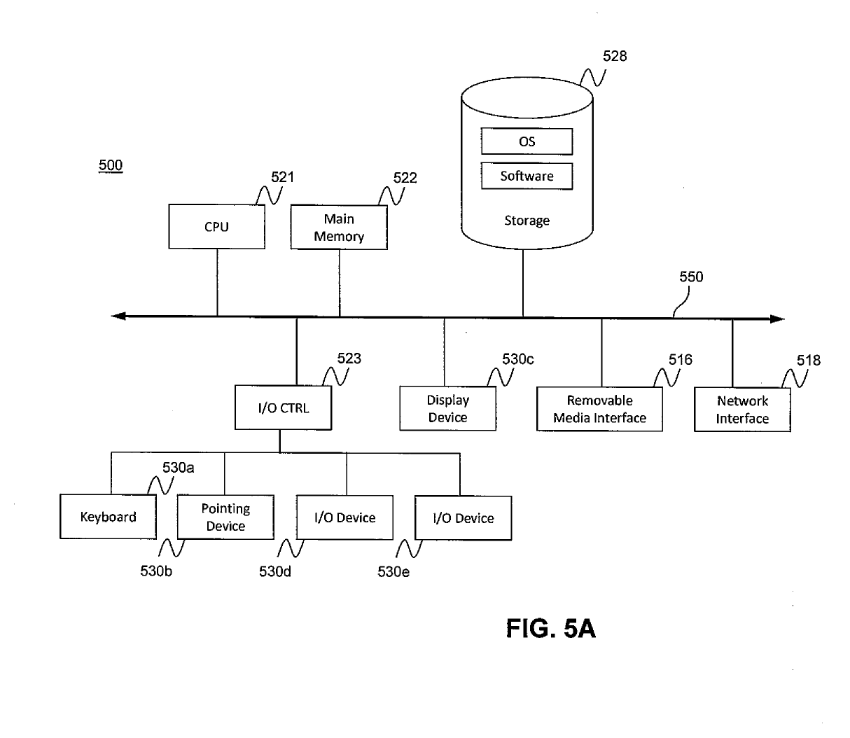

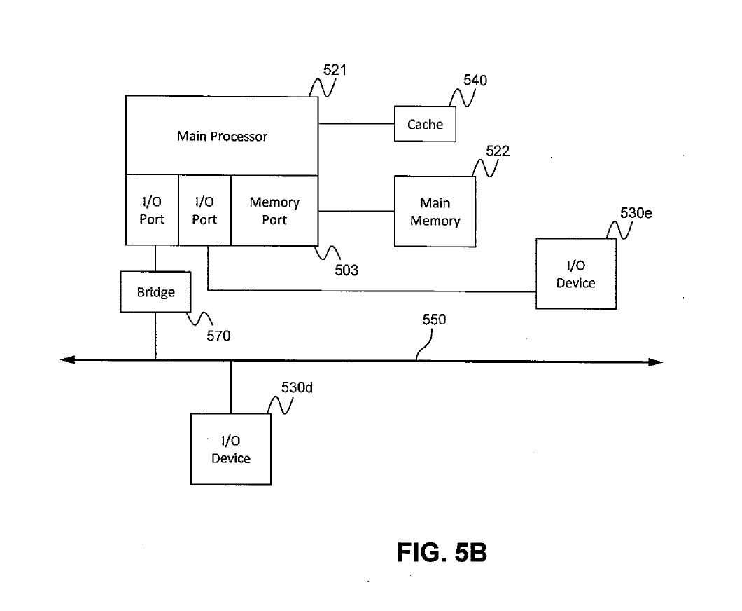

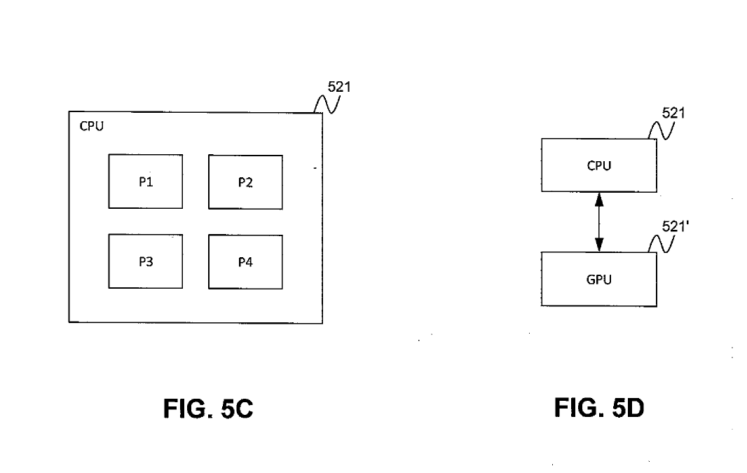

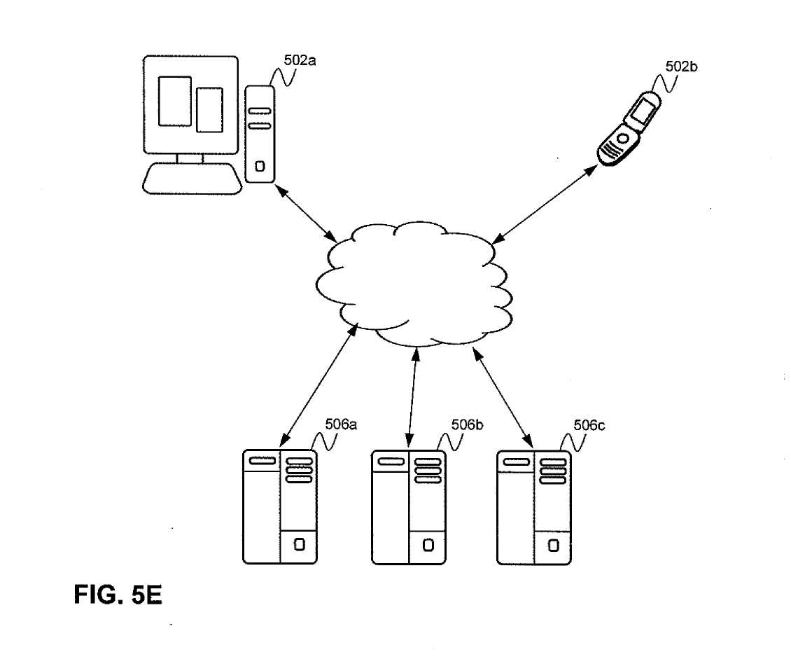

Each of the various servers in the contact center may be a process or thread, running on one or more processors, in one or more computing devices 500 (e.g., FIG. 5A, FIG. 5B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

FIG. 2 is a schematic block diagram showing the high level architecture of a rules system 44 and client applications of the rules system, according to an embodiment of the present invention. Various client applications, such as an automated voice response system 902, iWD server 42, interaction server 940, orchestration/routing server 904, may call on the rules system 44 for applying any rules that may be applicable for a current interaction. In one embodiment, the iWD server 42 has a business context management service that acts as a layer between the interaction server 940 and/or orchestration/routing server 904, and the rules engine 964. When an interaction comes in, the business context management service adds iWD server-specific data and passes the request to the rules engine 964. The rules engine 964 responds to the business context management service with the processed interaction and the business context management service sends the processed interaction back to the interaction server 940 and/or orchestration/routing server 904. The orchestration/routing server 904 may be a server including, among other capabilities, the functionality of a URS 20.

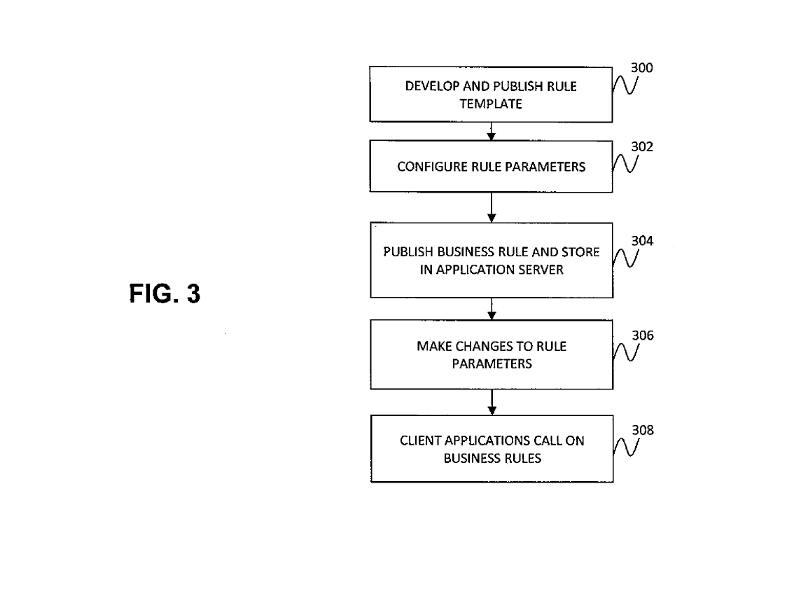

FIG. 3 is a flow chart of a process of creating a business template and a business rule according to an embodiment of the present invention. The process may be described in terms of a software routine executed by one or more processors based on computer program instructions stored in memory. A person of skill in the art should recognize, however, that the process may be executed via hardware, firmware, or a combination of software, firmware, and/or hardware. Furthermore, the sequence of acts of the process is not fixed, but may be altered into any desired sequence as recognized by a person of skill in the art.

According to an embodiment, in act 300 a technical user develops a template for a business rule using a composer tool 906. According to one embodiment, the composer tool incorporates a rules development tool 908 which a technical user may use to develop templates and publish the templates to a rule repository 968 (FIG. 2).

In act 302 a business user configures parameters of a business rule using a rules authoring tool 970. According to one embodiment, the rules authoring tool includes a rules authoring client 912 and a rules authoring server 914. In an exemplary embodiment of the present invention, the business user configures the rule parameters according to the enterprise's specific business requirements. As shown in FIG. 2, the rules authoring tool 970 may be a Web-based interface. After configuring the rule parameters (e.g., setting all conditions and actions in the rule template), the business user may publish or deploy the rule (or a rule package) to the rules engine 964 in an application server 963. The rules engine may be based on Drools 966, an open source business rules management system.

In this manner, business users may develop rules and routing logic based on their enterprise's business requirements. If an enterprise's business requirements change, the business user changes the logic of rules by modifying, for example, the rule parameters via the rules authoring tool, and, in act 304, publishes the changes to the rules repository 968. Rule parameters may therefore be more easily changed.

After the rule has been published, in act 306 the business user may make changes to the business rule using the rules authoring tool 970. These changes may be made over time. Moreover, additional logic changes can either be published immediately or at a set time, depending on the business user's preference.

In act 308, the business rules stored in the application server 963 are applied when the various client applications (e.g., iWD server 42, interaction server 940, orchestration/routing server 904, or any other application written by the customer) call on the rules system 44. For example, multiple rule packages for different aspects of the enterprise's business may reside on the application server 963, servicing requests by different client applications. As used herein, the term “rule package” refers to an executable item deployed to the application server 963, which includes one or more rules, a fact model, and any functions or other items necessary for the package to be a standalone item executable by the rules engine 964. The rules are deployed to the client applications via an application programming interface (API), which in some implementations may utilize Representational State Transfer (REST) or an external service protocol (ESP). The Administrator 916 is an application that is used by system administrators to configure the necessary properties and connections of the various system components such as the rules engine 964, composer tool 906, rules authoring tool 970, and the like.

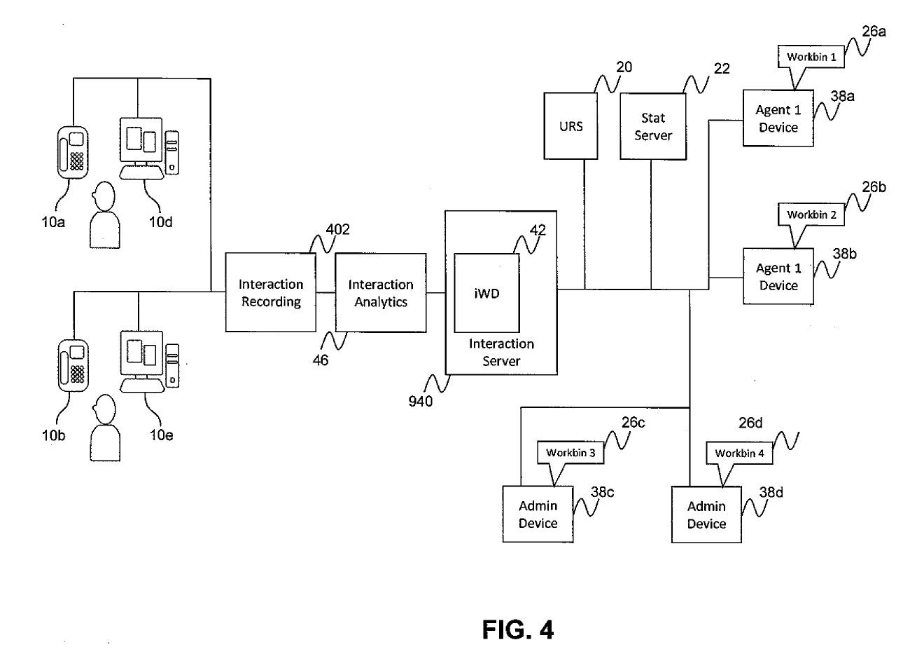

Referring to FIG. 4, in one exemplary embodiment, the interaction analytics server 46 and the iWD server 42 interact to generate work items in response to detected issues, automatically and in real time, reducing the workload on contact center managers and allowing the system to respond more quickly and reliably when issues arise. For example, a manufacturer starting sales of a new product, such as a mobile phone, may receive a variety of inbound interactions from customers related to the new product, including requests for information, requests for help using the product, and complaints about problems with the product. The new product may for example have a relatively high defect rate in a component, such as the battery, resulting in customers complaining, in a high proportion of calls, about product behavior which may be explained by a battery problem. In this situation, the interaction analytics server 46 may identify a certain number of calls in which the customer's sentiment was one of dissatisfaction, and in which the topics discussed included the new model of the phone, and the phone's battery. When this stream of interaction characteristics is provided to the iWD server 42, a rule in the GRS 44 may, upon being evaluated, determine that the combination of customer sentiment and interaction topics has exceeded a threshold and is a reliable indication that there is a problem in the product related to the battery. At this point the iWD server 42 may create a work item for an employee to investigate the apparent battery-related problem, and to resolve it if it is determined that a problem in fact exists. The iWD server 42 may include information about agent skills or stakeholder skills required for the handling of the work item, and the routing server 20 may then assign the work item in part based on these skills. The iWD server 42 may, for example, in response to a series of customer complaints indicating a possible battery problem, generate a work item designated to be handled by an agent with hardware troubleshooting skills, who may be able to determine whether there have in fact been problems with the product's battery. The routing server 20 may then identify such an agent and assign the work item to that agent. In one embodiment the iWD server 42 may send the work item to a multimedia/social media server 24 (FIG. 1), which may in turn push the work item to a routing server 20, and the routing server may make the final routing decision. In one embodiment, the system may provide real-time feedback to an agent by displaying it on the agent's screen. The iWD server 42 may be a component of an interaction server 940, as illustrated in FIG. 4.

The iWD server 42 may also have information on the history of a customer's interactions with the contact center, which may further influence the work item generated. If, in another example, an agent receives a call in which the customer indicates that she is waiting for an insurance adjuster to show up, the iWD server 42 may generate a work item to check the scheduling of an insurance adjuster, and instruct the routing server 20 to assign the work item to an agent with access to the pertinent schedules.

As shown in FIG. 4, end users or customers using end user devices 10a, 10b, 10d, and 10e may interact with the contact center and their interactions may be recorded by an interaction recording system 402. The interaction analytics server 46 may analyze the interactions and extract characteristics such as topics, sentiment, satisfaction, or business outcome. The iWD server 42 may then, in coordination with the interaction analytics server 46, generate work items, which may, after being assigned to particular agents, e.g., by the routing server 20, be stored in agent workbins 26a, 26b. If a work item results from a previous interaction of a customer with an agent, e.g., a work item to follow up on an interaction with a dissatisfied customer, the iWD server 42 may recommend to the routing server 20 that the work item be assigned to the same agent, or the iWD may recommend that it not be assigned to the same agent. The iWD server 42 may also generate work items for stakeholders such as contact center supervisors or managers, and these may be placed in corresponding workbins 26c, 26d.

The interaction analytics server may perform this analysis employing various algorithms described in the '094 patent, the '750 application, the '242 application and the '581 application, and using approaches which may include category definition, acoustic modeling, language modeling, search algorithm, an optimality criterion, and confidence estimation. When analyzing a voice interaction, for example, the interaction analytics server may perform an acoustic separation of speakers to separate words spoken by the customer from words spoken by the agent. This may be accomplished in two passes. A first pass may be performed to mark, associate, or state for each time frame whether it is correlated to a first speaker or a second speaker. After performing a second, recognition pass, it may then be possible to estimate whether the first speaker is the agent or the customer based on what the speaker said. Afterwards, the linguistic content of each speaker may be checked and classified accordingly.

The interaction analytics server may also extract audio features from the interaction, i.e., it may extract non-linguistic features that are not related to the linguistic content of the conversation, for example, speaker turn changes, pitch modulation, type of channel, signal-to-noise ratio (SNR), silence, and predefined tones such as question, sarcasm, and disbelief. Such audio features may enable the interaction analytics server to assess customer sentiment and customer satisfaction. It may also enable the interaction analytics server to assess some aspects of an agent's performance, with, e.g., angry or sarcastic tones in the agent's speech suggesting a lack of politeness or professionalism.

When the interaction is not a voice interaction but, e.g., an email or chat interaction, the interaction analytics server may not need to perform analysis to identify the author of any words in the interaction, e.g., whether any particular word was produced by the agent or the customer, as this may be explicit in the interaction. The interaction analytics server may, however, nonetheless analyze the text of the interaction for, e.g., topics, sentiment, satisfaction, and business outcome.

The interaction analytics server also may use the context of the interaction, which may be inferred from other aspects of the interaction or from the interaction as a whole, to analyze any portion of the interaction. For example, if the interaction has been classified as being a call from a dissatisfied customer with a MACINTOSH™ computer, then this may provide context for analysis of any part of the interaction, and the language model would induce a probability distribution over all relevant word sequences conditioned on the call coming from a dissatisfied customer with a MACINTOSH™ computer. A relevant context may take into consideration, for example, what has happened in the interaction up to that point. For instance, if a customer states “it's illegal” at the beginning of an interaction, the expectation about whether subsequent statements from the customer communicate a litigation threat may be increased.

In another example, the interaction analytics server 46 may determine that in one or more interactions an agent attempted and failed to sell a product to a potential customer. In this case, the iWD server 42 may create a work item for another agent or for a stakeholder to review a record of the interaction to understand why the sale was not completed, and to contact the potential customer to attempt to complete the sale. The iWD server 42 may attach a recording or transcript of the previous interaction to the work item, for the recipient of the work item. This use case may apply also to situations in which the previous interaction did not involve an agent, e.g., an interaction in which a potential customer initiated an on-line order but did not complete it. The interaction analytics server 46 may also determine that an interaction did not resolve the issue about which a customer initiated an interaction, regardless of whether the agent has flagged the issue as resolved, and in response the iWD server 42 may generate a work item for the agent or for the agent's supervisor, and instruct the routing server 20 to route the work item accordingly.

The interaction analytics server 46 and iWD server 42 may be configured to analyze and respond to interactions in certain categories, such as certain service types, customer segments, or agent groups. For example, they may be configured to analyze interactions of newly hired agents for the quality of their customer service, to analyze recordings of IVR conversations, email, or SMS content, or to assess the satisfaction level, or historical satisfaction level, of a particular customer.

In one embodiment, the interaction analytics server 46 sends signals referred to as trigger tasks to the iWD server 42. A trigger task may be a notification of a characteristic or condition which merits the application of a rule and the generation of a work item, or which may merit such an action only if other similar trigger tasks are received by the iWD server 42 within a certain time interval. For example, the interaction analytics server 46 may identify an interaction related to a credit card balance enquiry, or an enquiry about fees, containing a negative or dissatisfied customer sentiment, and submit this observation as a trigger task to the iWD server 42. The trigger task may contain, for example, a unique interaction identifier, a customer sentiment, e.g., dissatisfaction, and several keywords, identifying for example the topic and subtopic of the call, such as a product and a particular issue with a product. In one example, a trigger task may for example contain as a topic a credit card enquiry and as a subtopic an enquiry about a balance or fee on the credit card.

The iWD server 42 may then have rules for handling trigger tasks, including rules for identifying and responding to rates or trends. For example, a rule may trigger an action when trigger tasks in a category exceed a certain rate, e.g., the number received within a certain time interval exceeds a threshold, or when a set of trigger tasks shows a trend, e.g., growing customer dissatisfaction with an aspect of a product. The interaction analytics server 46 may detect characteristics of interactions including customer sentiment and handling time, e.g., the amount of time a customer spends interacting with an agent, and generate corresponding trigger tasks. The iWD server 42, receiving these trigger tasks, may evaluate a rule which determines that a particular agent's handling time has been increasing, and that the sentiment of customers interacting with the same agent has been becoming more negative or less positive. In this example the rule may generate a work item for the agent's supervisor to review a subset of the agent's transactions, or for the agent's supervisor to perform a certain type of training with the agent, to improve the agent's performance. The threshold level of customer sentiment, e.g., the minimum level of customer satisfaction which, if not met, triggers a requirement for agent training, may be specified in a service level agreement (SLA).

The work of analyzing characteristics of interactions may be shared by the interaction analytics server 46 and the iWD server 42, in a manner depending on the implementation and the type of analysis. For example, the interaction analytics server 46 may apply preconfigured criteria to the call characteristics, it identifies, and provide the results to the iWD server 42, or it may simply provide raw interaction characteristics to the iWD server 42, and the iWD server 42 may perform the remaining analysis by applying rules to the characteristics. The classification of a request sent to the interaction analytics server 46 as a trigger task is an example of an analysis act performed by the interaction analytics server 46; notifying the iWD server 42 that a request is a trigger task provides guidance to the iWD server 42 that the outcome of the application of some rules to the trigger task may depend on whether similar trigger tasks have been received within a certain time interval, or are subsequently received in a certain time interval.

In one exemplary embodiment, a trigger task may have associated with it, or included in it, a priority, which may be used by the iWD server 42 in determining what number of related trigger tasks are required before a work item is generated. For example, a trigger task indicating a suspected battery problem in a new product, resulting in reduced battery life, may be assigned a relatively modest priority. A trigger task indicating a suspected safety issue, such as an overheating battery or suspected fire hazard, may be assigned a high priority so that a single trigger task with this priority may be sufficient to result in a work item being generated to investigate and remedy the cause of the suspected problem. Thus, trigger tasks may be used to set up automated response to trends in characteristics of interactions. Trends in agent performance or politeness may also be identified using trigger tasks. In one exemplary embodiment, the iWD server 42 may respond to a trigger task by starting two tasks in the iWD server 42, one of which results in a work item being generated, e.g., to make a follow-up call to a customer, to address the cause of the customer's dissatisfaction, and another which runs for a certain time interval, monitoring whether other similar trigger tasks are received, and generating a work item, if a trend or pattern is detected. In one embodiment a mechanism is provided for a trend to be audited or modified, e.g., terminated, manually.

FIG. 5A and FIG. 5B depict block diagrams of a computing device 500 as may be employed in exemplary embodiments of the present invention. As shown in FIG. 5A and FIG. 5B, each computing device 500 includes a central processing unit 521, and a main memory unit 522. As shown in FIG. 5A, a computing device 500 may include a storage device 528, a removable media interface 516, a network, interface 518, an input/output (I/O) controller 523, one or more display devices 530c, a keyboard 530a and a pointing device 530b, such as a mouse. The storage device 528 may include, without limitation, storage for an operating system and software. As shown in FIG. 5B, each computing device 500 may also include additional optional elements, such as a memory port 503, a bridge 570, one or more additional input/output devices 530d, 530e and a cache memory 540 in communication with the central processing unit 521. Input/output devices, e.g., 530a, 530b, 530d, and 530e, may be referred to herein using reference numeral 530.

The central processing unit 521 is any logic circuitry that responds to and processes instructions fetched from the main memory unit 522. It may be implemented, for example, in an integrated circuit, in the form of a microprocessor, microcontroller, or graphics processing unit (GPU), or in a field-programmable gate array (FPGA) or application-specific integrated circuit (ASIC). Main memory unit 522 may be one or more memory chips capable of storing data and allowing any storage location to be directly accessed by the central processing unit 521. In the embodiment shown in FIG. 5A, the central processing unit 521 communicates with main memory 522 via a system bus 550. FIG. 5B depicts an embodiment of a computing device 500 in which the central processing unit 521 communicates directly with main memory 522 via a memory port 503.

FIG. 5B depicts an embodiment in which the central processing unit 521 communicates directly with cache memory 540 via a secondary bus, sometimes referred to as a backside bus. In other embodiments, the central processing unit 521 communicates with cache memory 540 using the system bus 550. Cache memory 540 typically has a faster response time than main memory 522. In the embodiment shown in FIG. 5A, the central processing unit 521 communicates with various I/O devices 530 via a local system bus 550. Various buses may be used as a local system bus 550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 530c, the central processing unit 521 may communicate with the display device 530c through an Advanced Graphics Port (AGP). FIG. 5B depicts an embodiment of a computer 500 in which the central processing unit 521 communicates directly with I/O device 530e. FIG. 5B also depicts an embodiment in which local busses and direct communication are mixed: the central processing unit 521 communicates with I/O device 530d using a local system bus 550 while communicating with I/O device 530e directly.

A wide variety of I/O devices 530 may be present in the computing device 500. Input devices include one or more keyboards 530a, mice, trackpads, trackballs, microphones, and drawing tablets. Output devices include video display devices 530c, speakers, and printers. An I/O controller 523, as shown in FIG. 5A, may control the I/O devices. The I/O controller may control one or more I/O devices such as a keyboard 530a and a pointing device 530b, e.g., a mouse or optical pen.

Referring again to FIG. 5A, the computing device 500 may support one or more removable media interfaces 516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 530 may be a bridge between the system bus 550 and a removable media interface 516.

The removable media interface 516 may for example be used for installing software and programs. The computing device 500 may further comprise a storage device 528, such as one or more hard disk drives or hard disk drive arrays, for storing an operating system and other related software, and for storing application software programs. Optionally, a removable media interface 516 may also be used as the storage device. For example, the operating system and the software may be run from a bootable medium, for example, a bootable CD.

In some embodiments, the computing device 500 may comprise or be connected to multiple display devices 530c, which each may be of the same or different type and/or form. As such, any of the I/O devices 530 and/or the I/O controller 523 may comprise any type and/or form of suitable hardware, software, or combination of hardware and software to support, enable or provide for the connection to, and use of, multiple display devices 530c by the computing device 500. For example, the computing device 500 may include any type and/or form of video adapter, video card, driver, and/or library to interface, communicate, connect or otherwise use the display devices 530c. In one embodiment, a video adapter may comprise multiple connectors to interface to multiple display devices 530c. In other embodiments, the computing device 500 may include multiple video adapters, with each video adapter connected to one or more of the display devices 530c. In some embodiments, any portion of the operating system of the computing device 500 may be configured for using multiple display devices 530c. In other embodiments, one or more of the display devices 530c may be provided by one or more other computing devices, connected, for example, to the computing device 500 via a network. These embodiments may include any type of software designed and constructed to use the display device of another computing device as a second display device 530c for the computing device 500. One of ordinary skill in the art will recognize and appreciate the various ways and embodiments that a computing device 500 may be configured to have multiple display devices 530c.

A computing device 500 of the sort depicted in FIG. 5A and FIG. 5B may operate under the control of an operating system, which controls scheduling of tasks and access to system resources. The computing device 500 may be running any operating system, any embedded operating system, any real-time operating system, any open source operating system, any proprietary operating system, any operating systems for mobile computing devices, or any other operating system capable of running on the computing device and performing the operations described herein.

The computing device 500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 500 may have different processors, operating systems, and input devices consistent with the device.

In other embodiments the computing device 500 is a mobile device, such as a Java-enabled cellular telephone or personal digital assistant (PDA), a smart phone, a digital audio player, or a portable media player. In some embodiments, the computing device 500 comprises a combination of devices, such as a mobile phone combined with a digital audio player or portable media player.

As shown in FIG. 5C, the central processing unit 521 may comprise multiple processors P1, P2, P3, P4, and may provide functionality for simultaneous execution of instructions or for simultaneous execution of one instruction on more than one piece of data. In some embodiments, the computing device 500 may comprise a parallel processor with one or more cores. In one of these embodiments, the computing device 500 is a shared memory parallel device, with multiple processors and/or multiple processor cores, accessing all available memory as a single global address space. In another of these embodiments, the computing device 500 is a distributed memory parallel device with multiple processors each accessing local memory only. In still another of these embodiments, the computing device 500 has both some memory which is shared and some memory which may only be accessed by particular processors or subsets of processors. In still even another of these embodiments, the central processing unit 521 comprises a multicore microprocessor, which combines two or more independent processors into a single package, e.g., into a single integrated circuit (IC). In one exemplary embodiment, depicted in FIG. 5D, the computing device 500 includes at least one central processing unit 521 and at least one graphics processing unit 521′.

In some embodiments, a central processing unit 521 provides single instruction, multiple data (SIMD) functionality, e.g., execution of a single instruction simultaneously on multiple pieces of data. In other embodiments, several processors in the central processing unit 521 may provide functionality for execution of multiple instructions simultaneously on multiple pieces of data (MIMD). In still other embodiments, the central processing unit 521 may use any combination of SIMD and MIMD cores in a single device.

A computing device may be one of a plurality of machines connected by a network, or it may comprise a plurality of machines so connected. FIG. 5E shows an exemplary network environment. The network environment comprises one or more local machines 502a, 502b (also generally referred to as local machine(s) 502, client(s) 502, client node(s) 502, client machine(s) 502, client computer(s) 502, client device(s) 502, endpoint(s) 502, or endpoint node(s) 502) in communication with one or more remote machines 506a, 506b, 506c (also generally referred to as server machine(s) 506 or remote machine(s) 506) via one or more networks 504. In some embodiments, a local machine 502 has the capacity to function as both a client node seeking access to resources provided by a server machine and as a server machine providing access to hosted resources for other clients 502a, 502b. Although only two clients 502 and three server machines 506 are illustrated in FIG. 5E, there may, in general, be an arbitrary number of each. The network 504 may be a local-area network (LAN), e.g., a private network such as a company Intranet, a metropolitan area network (MAN), or a wide area network (WAN), such as the Internet, or another public network, or a combination thereof.

The computing device 500 may include a network interface 518 to interface to the network 504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 500 communicates with other computing devices 500 via any type and/or form of gateway or tunneling protocol such as Secure Socket Layer (SSL) or Transport Layer Security (TLS). The network interface 518 may comprise a built-in network adapter, such as a network interface card, suitable for interfacing the computing device 500 to any type of network capable of communication and performing the operations described herein. An I/O device 530 may be a bridge between the system bus 550 and an external communication bus.

Although exemplary embodiments of the actionable workflow based on interaction analytics analysis have been specifically described and illustrated herein, many modifications and variations will be apparent to those skilled in the art. Accordingly, it is to be understood that the actionable workflow based on interaction analytics analysis constructed according to principles of this invention may be embodied other than as specifically described herein. The invention is also defined in the following claims, and equivalents thereof.

1. A method for assigning a work item to a target, the method comprising,
analyzing, by a computing device, a plurality of interactions between end users and employees, to extract a plurality of characteristics from the plurality of interactions;
applying a business rule to the plurality of characteristics;
generating a work item in response to the application of the business rule; and
assigning the work item to a target.

2. The method of claim 1, wherein one of the plurality of interactions is a telephone call.

3. The method of claim 1, wherein a characteristic of the plurality of characteristics is selected from the group consisting of: interaction topic, end user sentiment, agent sentiment, end user satisfaction, business outcome, and combinations thereof.

4. The method of claim 1, wherein the analyzing is performed by a first server and the generating is performed by a second server, in response to receiving a signal from the first server.

5. The method of claim 4, wherein the signal comprises a trigger task.

6. The method of claim 5, wherein the second server generates the work item in response to receiving a plurality of trigger tasks indicating a trend in a characteristic.

7. The method of claim 6, wherein the trend is an increasing value of a characteristic.

8. The method of claim 5, wherein the second server generates the work item in response to receiving a plurality of trigger tasks indicating a rate of interactions with a characteristic.

9. The method of claim 1, wherein the target is a contact center agent.

10. The method of claim 1, wherein the target is a contact center stakeholder.

11. A system for assigning a work item to a target, the system comprising:
a processor; and
a memory, wherein the memory has stored thereon instructions that, when executed by the processor, cause the processor to:
analyze, a plurality of interactions between end users and employees, to extract a plurality of characteristics from the plurality of interactions;
apply a business rule to the plurality of characteristics;
generate a work item in response to the application of the business rule; and
assign the work item to a target.

12. The system of claim 11, wherein one of the plurality of interactions is a telephone call.

13. The system of claim 11, wherein a characteristic of the plurality of characteristics is selected from the group consisting of interaction topic, end user sentiment, agent sentiment, end user satisfaction, business outcome, and combinations thereof.

14. The system of claim 11, wherein the analyzing is performed by a first server and the generating is performed by a second server, in response to receiving a signal from the first server.

15. The system of claim 14, wherein the signal comprises a trigger task.

16. The system of claim 15, wherein the second server generates the work item in response to receiving a plurality of trigger tasks indicating a trend in a characteristic.

17. The system of claim 16, wherein the trend is an increasing value of a characteristic.

18. The system of claim 15, wherein the second server generates the work item in response to receiving a plurality of trigger tasks indicating a rate of interactions with a characteristic.

19. The system of claim 11, wherein the target is a contact center agent.

20. The system of claim 11, wherein the target is a contact center stakeholder.

21. The method of claim 1, wherein the target is an automated response device and the work item is for setting up an automated response based on the extracted plurality of characteristics.
